(19) United States
(12) Patent Application Publication
(10) Pub. No.: US 2015/0353232 A1
(43) Pub. Date: Dec. 10, 2015

(54) SIZE-ADJUSTABLE RECEPTACLE

(71) Applicant: Edward KANDEL, McHenry, IL (US)

(72) Inventor: Edward KANDEL, McHenry, IL (US)

(21) Appl. No.: 14/297,931

(22) Filed: Jun. 6, 2014

(51) Int. Cl. B65D 21/08; B65D 6/04; B65D 6/02; A01G 9/02; B65D 25/04; B65D 25/54; A01K 1/015; A01K 63/00; A47G 23/06; B65D 6/00

(52) U.S. Cl. CPC B65D 21/083; A47G 23/06; B65D 7/08; B65D 9/06; B65D 11/10; B65D 13/04; B65D 25/04; B65D 25/54; A01K 1/0157; A01K 63/006; A01G 9/028

(57) ABSTRACT

An apparatus and parts for forming a size-adjustable receptacle are disclosed. In some embodiments, a part of a receptacle is provided, the receptacle being assembled from a plurality of parts. The part of the receptacle includes a surface having formed therein a plurality of protrusions suitable to mate in interlocking cooperation with protrusions of a second and third part of the receptacle, such that a choice of which protrusions of the first part to mate with protrusions of the second and third parts, determines a size of the receptacle.

### TECHNICAL FIELD

The present invention relates to a size-adjustable receptacle.

### BACKGROUND

There are many uses of receptacles of a fixed size. For example: a tray that slides under a pet cage; a tray used to hold plants; a food tray to hold food; a cargo liner for a truck; a floor mat; a receptacle to line a tool box or hold gravel in a fish tank.

### SUMMARY

The present invention advantageously provides a size-adjustable receptacle and parts therefor. According to one aspect, a size-adjustable receptacle includes a first part and a second part. The first part has a generally flat portion and edges. The first part has a first set of interlocking nodes along a first direction perpendicular to an edge and a second set of interlocking nodes along a second direction orthogonal to the first direction. The second part has a generally flat portion and has at least a third interlocking node and at least a fourth interlocking node. The third and fourth interlocking nodes are oriented to simultaneously interlock with at least one of the first set of interlocking nodes and at least one of the second set of interlocking nodes, respectively. The first and second parts are selectively overlapping to at least partially determine at least one of a length and a width of the size-adjustable receptacle.

According to another aspect, a collection of parts is provided that, when assembled, form one of a tray and a vessel. The collection of parts includes a first part having a first set of interlocking nodes along a first direction and a second set of interlocking nodes along a second orthogonal direction. A second part has a third set of interlocking nodes and a fourth set of interlocking nodes. The first set and the second set are orient-able to mate and interlock with at least the third set and the fourth set, respectively. The first part and the second part are position-able such that the at least some of the interlocking nodes overlap to determine at least one of a length and a width of the one of the tray and the vessel.

According to yet another aspect, a part of a receptacle is provided, the receptacle being assembled from a plurality of parts. The part of the receptacle includes a surface having formed therein a plurality of interlocking nodes suitable to mate in interlocking cooperation with interlocking nodes of a second and third part of the receptacle, such that a choice of which interlocking nodes of the first part to mate with interlocking nodes of the second and third parts, determines a size of the receptacle.

### BRIEF DESCRIPTION OF THE DRAWINGS

FIG. 1 is an assembled size-adjustable receptacle constructed in accordance with methods and parts described herein;

FIG. 2 is a corner part of a size-adjustable receptacle with interlocking nodes;

FIG. 3 is a cut-away view of two parts overlapping and interlocking by mating interlocking nodes;

FIG. 4 is an edge view of an outer edge of an interlocking part;

FIG. 5 is an illustration of two interlocking part positioned to overlap by mating interlocking nodes;

FIG. 6 is an edge view of a part that has a divider formed therein for creating a receptacle with separated regions;

FIG. 7 is a corner part of a size-adjustable receptacle having perforated holes; and

FIG. 8 is a corner part of a size-adjustable receptacle having rectangular slots.

### DETAILED DESCRIPTION

Before describing in detail exemplary embodiments that are in accordance with the present invention, it is noted that the embodiments reside primarily in combinations of apparatus components and processing steps related to size-adjustable receptacles. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

As used herein, the term “receptacle” includes a tray, a vessel, a pan, a liner, a mat, a basin, a holder, a container, or object configurable to hold or support a substance. As used herein, the term “interlocking nodes” or interlocking entities include protuberances, mating entities, fittings, or objects shaped to mate with complementary-shaped objects. To “interlock” means to removably or irremovably affix or mate two interlocking entities. In some embodiments, to interlock may call for the application of slight force to snap the two complementary shaped features together. In removably-affixable embodiments, slight force may be called for to separate the interlocked parts.

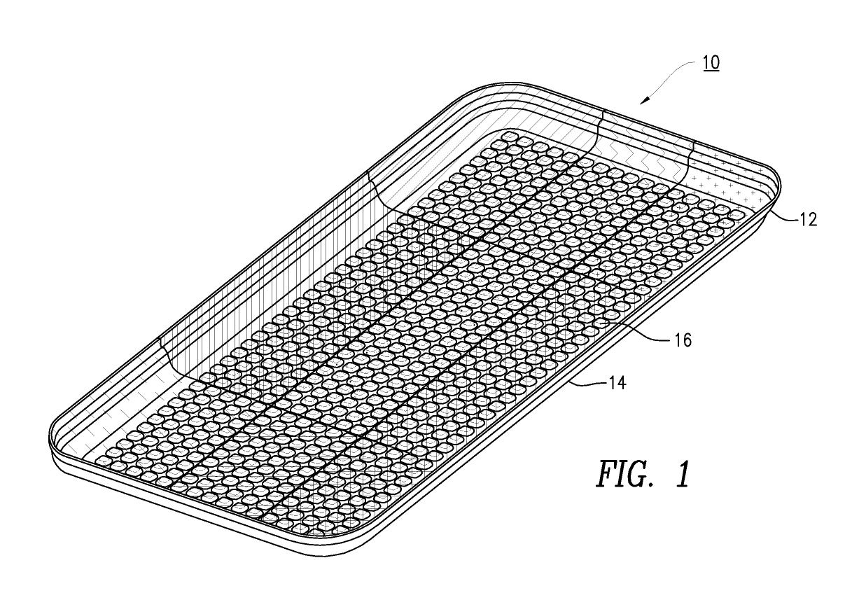

FIG. 1 shows an assembled size-adjustable receptacle 10 that consists of 9 parts: 4 corner parts 12 and 5 center parts 14. The number of parts shown in FIG. 1 is representative of one embodiment. Other embodiments may have different numbers of parts, such as, for example, four corner parts. In some embodiments, each part contains at least one row of interlocking entities 16. The interlocking entities 16 of one part are interlocked with interlocking entities 16 of an adjacent part. By adjusting the extent of overlap of adjacent parts, the size of the receptacle 10 can be adjusted in length and/or width. The receptacle 10 can be assembled by interlocking the overlapping interlocking entities of adjacent parts by pressing firmly to snap the parts together Note further, that by adding center pieces such as center parts 14, the receptacle can be made of any desired size, and could even, for example, cover an entire floor of a large room. For example, the receptacle could be used to hold concrete forming a floor of a room or building.

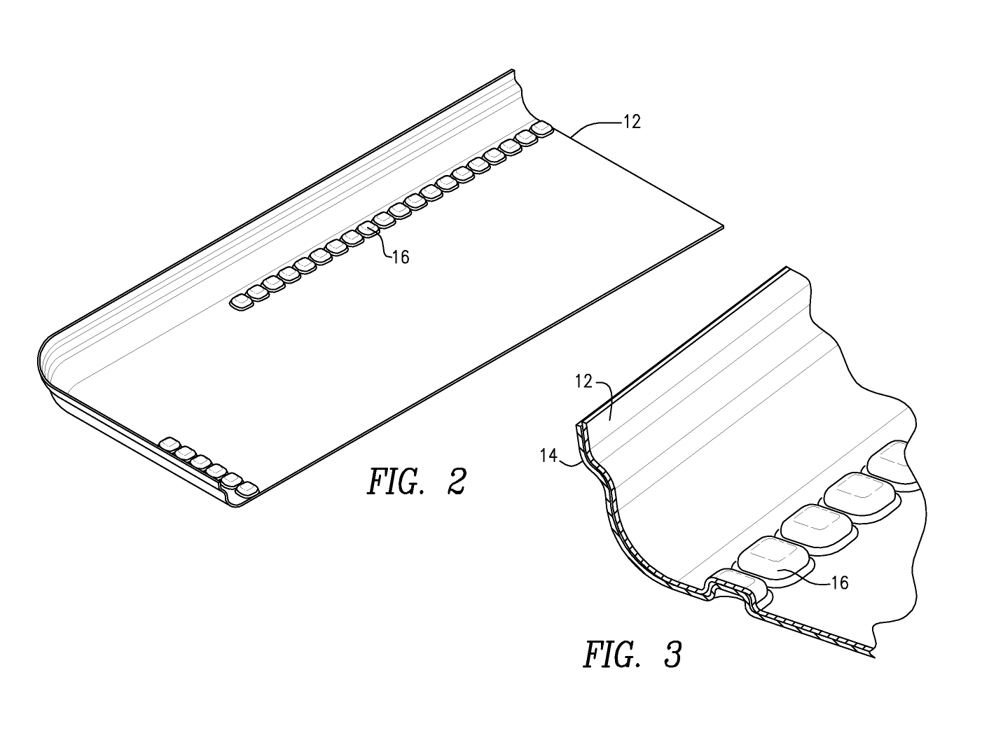

FIG. 2 shows a corner part 12 with interlocking nodes 16. Although only one row of interlocking nodes 16 is shown on each edge in orthogonal directions, in some embodiments, more rows in one or both directions may be included.

FIG. 3 shows a cut-away view of two parts 12 and 14 overlapping and interlocked by mating interlocking nodes 16. Note that although the drawing figures show only square interlocking nodes, in some embodiments, other shapes of interlocking nodes can be employed. Note also, that in some embodiments, at least some of the interlocking nodes are located near an outer wall and near an edge where the two parts overlap when the size-adjustable receptacle is assembled. In some embodiments, the interlocking entities are located on the outer walls of parts to be joined.

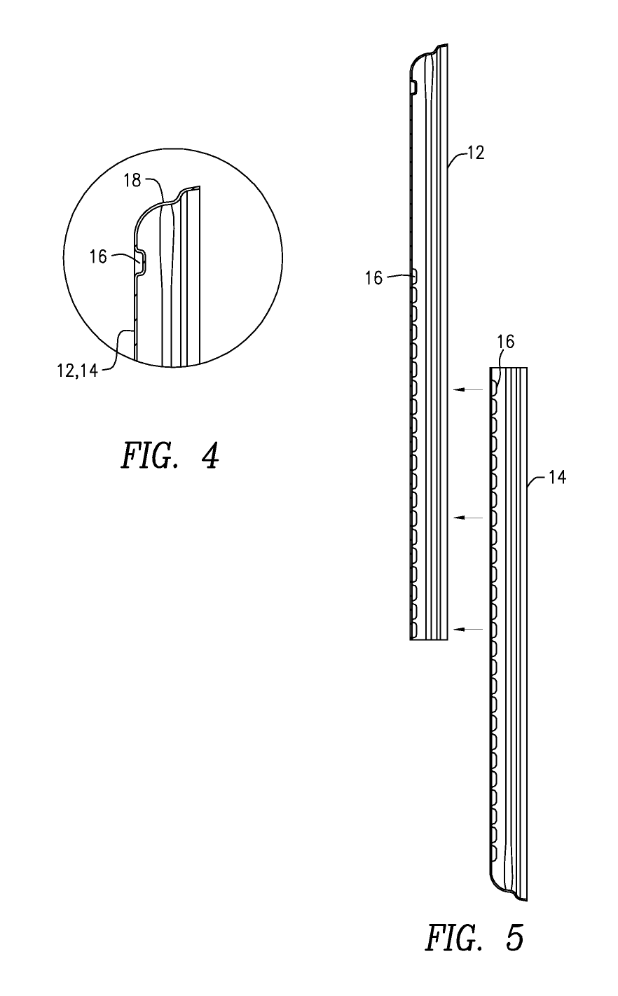

FIG. 4 shows an edge view of the outer edge of an interlocking part 12, 14 having interlocking nodes 16. In this embodiment, the interlocking part exhibits a curved wall 18 on the outer edge. The curved wall 18 gives the receptacle depth when assembled. The depth of the receptacle is determined by the height of the wall 18. Thus, a deep receptacle or a shallow receptacle can be made. For example, a shallow wall may be employed when forming a tray. In alternative embodiments, the interlocking parts have no wall 18, so that the receptacle is flat—except for the nodes—having no depth.

FIG. 5 shows two interlocking parts 12, 14 positioned to overlap and be assembled by mating interlocking nodes 16. The extent of overlap at least in part determines a size of the finally-assembled receptacle.

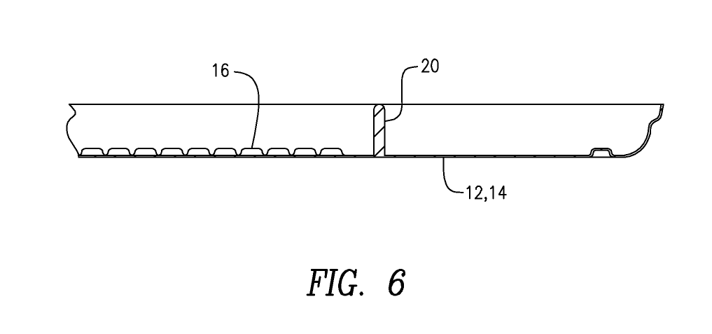

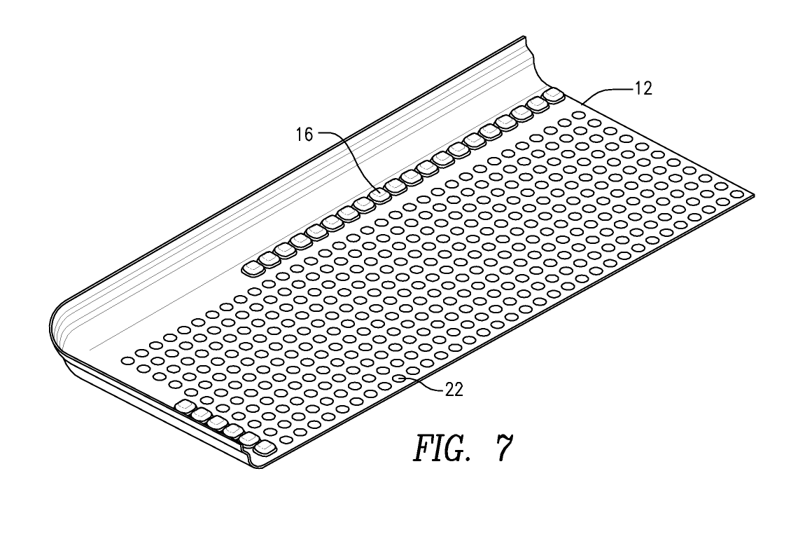

FIG. 6 is an edge view of a part 12, 14 that has a divider 20 formed therein for creating a receptacle 10 with a divider to separate the assembled receptacle into different section or regions. In some embodiments, the divider 20 is the same height as the wall 18.

FIG. 7 is a corner part of a size-adjustable receptacle having perforated holes. The perforated holes may be desired in applications, such as plant trays, where the receptacle is to hold solid matter but not liquid matter.

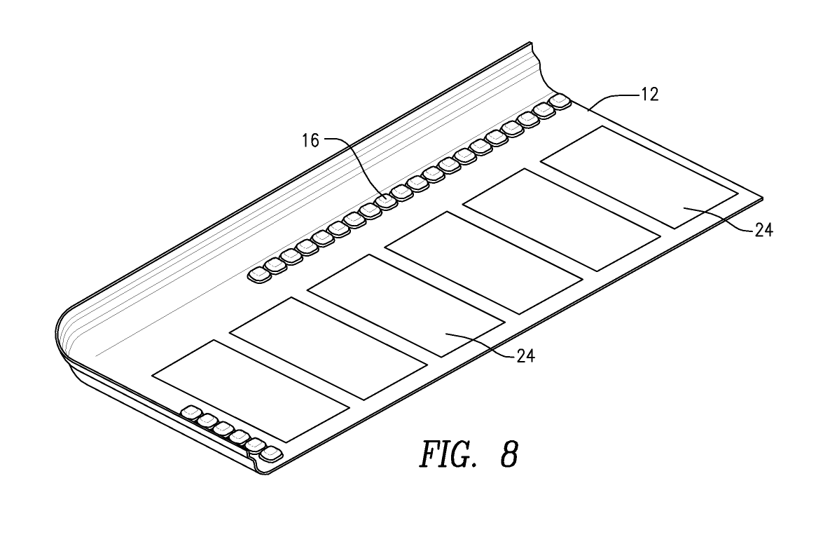

FIG. 8 is a corner part of a size-adjustable receptacle having rectangular slots. The rectangular slots may be desired in applications where the receptacle is used as a concrete reinforcement structure, for example.

As shown in the drawing figures, in some embodiments an interlocking entity is a protuberance having a size that is substantially smaller than a size of a part containing the protuberance. In some embodiments, the interlocking node may be elongated or much larger.

The size-adjustable receptacle may be used as one of a plant tray, a food tray, a liquid vessel, a drawer liner, a cargo liner, a floor mat, a receptacle that slides under an object, a tool box liner, a gravel holder for one of a fish tank and a reptile tank, a pet cage liner, a liner for an animal pen, a sand box, for spill containment and a shelf liner. In some embodiments, at least one part of the size-adjustable receptacle is one of rigid and flexible, one of biodegradable, paper, cardboard, wood pulp, metal, recyclable and plastic, and one of transparent, opaque, colored, reflective and diffuse. In some embodiments, at least one part is formed by one of a thermoform process, an injection mold process, a compression mold function, a stamping process, a casting process and an extrusion process. In some embodiments, like parts of the disassembled size-adjustable receptacle stackable, one part fitting at least partially inside another.

Thus, one embodiment is a size-adjustable receptacle that includes a first part and a second part. The first part has a generally flat portion and edges. The first part has a first set of interlocking nodes along a first direction perpendicular to an edge and a second set of interlocking nodes along a second direction orthogonal to the first direction. The second part has a generally flat portion and has at least a third interlocking node and at least a fourth interlocking node. The third and fourth interlocking nodes are oriented to simultaneously interlock with at least one of the first set of interlocking nodes and at least one of the second set of interlocking nodes, respectively. The first and second parts are selectively overlapping to at least partially determine at least one of a length and a width of the size-adjustable receptacle.

In some embodiments, the first set and the second set of interlocking nodes merge to cover substantially the entire flat portion of the first part. In some embodiments, the first set of interlocking nodes are arranged in a first set of rows and the second set of interlocking nodes are arranged in a second set of rows. In some embodiments, the at least a first interlocking node of the second part includes at least one row of interlocking nodes. In some embodiments, at least one of the two parts forms a corner of the size-adjustable receptacle and the other of the two parts is a center part that does not form a corner of the size-adjustable receptacle.

In some embodiments, at least one of the two parts has at least one outside edge that is raised to form an outer wall of a desired height so that when assembled, the size-adjustable receptacle exhibits a desired depth. In some embodiments, the size adjustable receptacle further includes at least two additional parts having interlocking nodes and wherein four parts each exhibit corners, so that when the four parts are assembled by mating interlocking nodes, the size-adjustable receptacle is one of a tray and a vessel having four corners.

The width and the length of the size-adjustable receptacle may both be at least partially determined by an amount of overlap of at least four parts when assembled. In some embodiments, at least one of the two parts exhibits at least one divider such that the size-adjustable receptacle is partitioned into at least two separate sections when assembled. In some embodiments, the at least two parts are substantially flat except for interlocking nodes, so that the size-adjustable receptacle is a substantially flat tray without sides.

Another embodiment is a collection of parts that, when assembled, form a receptacle. The collection of parts includes a first part having a first set of protuberances along a first direction and a second set of protuberances along a second orthogonal direction. A second part has a third set of protuberances and a fourth set of protuberances. The first set and the second set are orient-able to mate and interlock with at least the third set and the fourth set, respectively. The first part and the second part are position-able such that the at least some of the protuberances overlap to determine at least one of a length and a width of the receptacle.

In some embodiments, at least one of the first and second parts has a raised edge forming a wall of the receptacle. In some embodiments, all of the parts are substantially flat except for the interlocking nodes and none of the parts has a raised edge, the collection of parts thereby forming, when assembled, a flat tray having no walls. In some embodiments, the parts include corner parts exhibiting corners of the one of the tray and the vessel. In some embodiments, the first set of interlocking nodes are located on a wall at an edge of the first part and the third set of interlocking nodes are located on a wall at an edge of the second part.

According to yet another aspect, a part of a receptacle is provided, the receptacle being assembled from a plurality of parts. The part of the receptacle includes a surface having formed therein a plurality of protrusions suitable to mate in interlocking cooperation with protrusions of a second and third part of the receptacle, such that a choice of which protrusions of the first part to mate with protrusions of the second and third parts, determines a size of the receptacle. In some embodiments, the part is configured so that like parts of disassembled receptacles are stackable, one part fitting at least partially inside another.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A size-adjustable receptacle, comprising:
a first part having a generally flat portion and edges, the first part having a first set of interlocking nodes along a first direction perpendicular to an edge and a second set of interlocking nodes along a second direction orthogonal to the first direction; and
a second part having a generally flat portion and having at least a third interlocking node and at least a fourth interlocking node, the third and fourth interlocking nodes oriented to simultaneously interlock with at least one of the first set of interlocking nodes and at least one of the second set of interlocking nodes, respectively, the first and second parts selectively overlapping to at least partially determine at least one of a length and a width of the size-adjustable receptacle.

2. The size-adjustable receptacle of claim 1, wherein the first set and the second set of interlocking nodes merge to cover substantially the entire flat portion of the first part.

3. The size-adjustable receptacle of claim 1, wherein the first set of interlocking nodes are arranged in a first set of rows and the second set of interlocking nodes are arranged in a second set of rows.

4. The size-adjustable receptacle claim 1, wherein the at least a first interlocking node of the second part includes at least one row of interlocking nodes.

5. The size-adjustable receptacle of claim 1, wherein at least one of the two parts forms a corner of the size-adjustable receptacle and the other of the two parts is a center part that does not form a corner of the size-adjustable receptacle.

6. The size-adjustable receptacle of claim 1, wherein at least one of the two parts has at least one outside edge that is raised to form an outer wall of a desired height so that when assembled, the size-adjustable receptacle exhibits a desired depth.

7. The size-adjustable receptacle of claim 1, further comprising at least two additional parts having interlocking nodes and wherein four parts each exhibit corners, so that when the four parts are assembled by mating interlocking nodes, the size-adjustable receptacle is one of a tray and a vessel having four corners.

8. The size-adjustable receptacle of claim 7, wherein the width and the length of the size-adjustable receptacle are both at least partially determined by an amount of overlap of at least four parts when assembled.

9. The size-adjustable receptacle of claim 1, wherein at least one of the two parts exhibits at least one divider such that the size-adjustable receptacle is partitioned into at least two separate sections when assembled.

10. The size-adjustable receptacle of claim 1, wherein the two parts are substantially flat except for interlocking nodes, so that the size-adjustable receptacle is a substantially flat tray without sides.

11. The size-adjustable receptacle of claim 1, wherein the at least two parts can be assembled to form a size-adjustable receptacle useable as one of a plant tray, a food tray, a liquid vessel, a drawer liner, a cargo liner, a floor mat, a receptacle that slides under an object, a tool box liner, a gravel holder for one of a fish tank and a reptile tank, a pet cage liner, a liner for an animal pen, a sand box, for spill containment and a shelf liner.

12. The size-adjustable receptacle of claim 1, wherein at least one part of the size-adjustable receptacle is one of rigid and flexible, and one of biodegradable, paper, cardboard, wood pulp, metal, recyclable material, plastic, and one of transparent, opaque, colored, reflective and diffuse.

13. The size-adjustable receptacle of claim 1, wherein at least one part is formed by one of a thermoform process, an injection mold process, a compression mold function, a stamping process, a casting process and an extrusion process.

14. A collection of parts that, when assembled, form a receptacle, the collection of parts comprising:
a first part having a first set of interlocking nodes along a first direction and a second set of interlocking nodes along a second orthogonal direction;
a second part having a third set of interlocking nodes and a fourth set of interlocking nodes, the first set and the second set orient-able to mate and interlock with at least a portion of the third set and the fourth set, respectively, when the first part and the second part are positioned such that at least some of the interlocking nodes overlap to determine at least one of a length and a width of the one of the receptacle.

15. The collection of parts of claim 14, wherein at least one of the first and second parts has a raised edge forming a wall of the receptacle.

16. The collection of parts of claim 14, wherein all of the parts are substantially flat except for the interlocking nodes and none of the parts has a raised edge, the collection of parts thereby forming, when assembled, a flat tray having no walls.

17. The collection of parts of claim 14, further comprising corner parts exhibiting corners of the one of the receptacle.

18. The collection of parts of claim 14, wherein the first set of interlocking nodes are located on a wall at an edge of the first part and the third set of interlocking nodes are located on a wall at an edge of the second part.

19. A part of a receptacle, the receptacle being assembled from a plurality of parts, the part of the receptacle comprising a surface having formed therein a plurality of interlocking nodes suitable to mate in interlocking cooperation with interlocking nodes of a second and third part of the receptacle, such that a choice of which interlocking nodes of the first part to mate with interlocking nodes of the second and third parts, determines a width and length of the receptacle.

20. The part of claim 19, wherein the part is configured so that like parts of disassembled receptacles are stackable, one part fitting at least partially inside another.
